(19) United States
(12) Patent Application Publication
(10) Pub. No.: US 2022/0068145 A1
(43) Pub. Date: Mar. 3, 2022

(54) SYSTEM, APPARATUS AND METHOD FOR IMPROVED AIRPORT AND RELATED VEHICLE OPERATIONS AND TRACKING

(71) Applicants: Michael A. Cummings, Dana Point, CA (US); Eric Jacobs, Great Falls, VA (US)

(72) Inventors: Michael A. Cummings, Dana Point, CA (US); Eric Jacobs, Great Falls, VA (US)

(21) Appl. No.: 17/412,555

(22) Filed: Aug. 26, 2021

Related U.S. Application Data
(60) Provisional application No. 63/070,583, filed on Aug. 26, 2020.

(51) Int. Cl. G08G 5/00; H04W 4/021; H04W 4/42; H04W 4/029

(52) U.S. Cl. CPC G08G 5/0013; H04W 4/029; H04W 4/42; H04W 4/022

(57) ABSTRACT

Embodiments of the present disclosure provide a system, device and method for collecting, processing, correcting and employing positional vehicle data broadcast by aircraft and/or other vehicles to improve airport and related vehicle operations and tracking. In various embodiments, an IOT sensor subsystem comprising a detection unit is secured at or near an airport and includes one or more antennae, one or more sensors and a processing unit for analyzing the data and producing beneficial output.

### CROSS-REFERENCE TO RELATED APPLICATIONS

The present application claims the priority benefit of U.S. Provisional Patent Application Serial No. 63/070,583, filed Aug. 26, 2020, the disclosure of which is incorporated by reference herein in its entirety.

### TECHNICAL FIELD

The present disclosure relates to aviation operations and, more particularly, to leveraging ADS-B data from vehicles for improved airport and related vehicle operations and tracking.

### BACKGROUND

Automatic dependent surveillance-broadcast (ADS-B) is part of the U.S.'s Next Generation Air Transportation System (NextGen) airspace strategy for upgrading and enhancing aviation infrastructure and operations. ADS-B can be considered as a replacement for radar as the primary surveillance method for controlling aircraft around the world. Under ADS-B Out, an individual aircraft regularly broadcasts information about itself, including identification information, position information, altitude information and velocity information through an onboard transmitter, Under ADS-B In, an aircraft receives ADS-B and other data from nearby aircraft. On-the-ground infrastructure can also operate ADS-B In to receive messages and other data from nearby aircraft. For purposes of the present disclosure, an “aircraft” or “aircraft vehicle” can be considered a vehicle capable of flight, including fixed and rotary wing aircraft as well as unmanned aerial vehicles (UAV) and systems (UAS), Further, for purposes of the present disclosure, a “vehicle” can be considered any type of vehicle which may include aircraft or vehicles involved in airport and aircraft operations, which may include emergency vehicles, aircraft repair vehicles, snow plows, runway inspection vehicles and the like.

As of Jan. 1, 2020, all aircraft operating in the U.S. are required to have ADS-B Out systems installed in their aircraft and functioning according to FAA regulations. ADS-B Out equipment in an aircraft transmits an “ADS-B Message” approximately once every second on one of two frequencies, 978 MHz or 1090 MHz. The information contained in an ADS-B Message varies according to the message type. There are six different ADS-B message types and eight message sub-types which adhere to the Surveillance and Broadcast Services (SBS) format. For purposes of the present disclosure, while all message types and sub-types can be employed, the message type “Aircraft Transmission Message” and sub-type messages 1, 2, 3, 4 and 6 may be primarily employed. Message sub-type 1 relates to an aircraft's identification and category; sub-type 2 relates to the aircraft's surface position message; sub-type 3 relates to the aircraft's airborne position; sub-type 4 relates to airborne velocity; and sub-type 6 relates to surveillance identification. These data sub-types can contain up to twenty-two data fields separated by commas, as illustrated in Table 1 below, adapted from http://woodair.net/sbs/article/barebones42_socket_data.htm. The first ten fields are considered standard for all messages, where Field 2 is used only for Message Type MSG. The remaining fields contain specific aircraft information.

TABLE 1

| Field | Item | Description |
|---|---|---|
| Field 1 | Message Type | MSG, STA, ID, AIR, SEL or CLK |
| Field 2 | Transmission Type | MSG subtypes 1 to 8, Not used by |
| | | other message types. |
| Field 3 | Session ID | Database Session record number |
| Field 4 | Aircraft ID | Database Aircraft record number |
| Field 5 | Hexident | Aircraft Mode S hexadecimal code |
| Field 6 | Flight ID | Database Flight record number |
| Field 7 | Date message generated | Date message generated |
| Field 8 | Time message generated | Time message generated |
| Field 9 | Date message logged | Date message logged |
| Field 10 | Time message logged | Time message logged |
| Field 11 | Callsign | Eight digit flightID - can be flight |
| | | number or registration (or nothing) |
| Field 12 | Altitude | Mode C altitude, Fleight relative to |
| | | 1013.2 mb (Flight Level) Not Height |
| | | AMSL |
| Field 13 | GroundSpeed | Speed over ground (not indicated |
| | | airspeed) |
| Field 14 | Track | Track of aircraft (not heading)- |
| | | derived from velocity East-West and |
| | | velocity North-South |
| Field 15 | Latitude | North and East positive. South and |
| | | West negative |
| Field 16 | Longitude | North and East positive. South and |
| | | West negative |
| Field 17 | VerticalRate | 64 ft. resolution |
| Field 18 | Squawk | Assigned Mode A squawk code |
| Field 19 | Alert (Squawk change) | Flag to indicate squawk has changed |
| Field 20 | Emergency | Flag to indicate emergency code has |
| | | been set |
| Field 21 | SPI (Ident) | Flag to indicate transponder Ident has |
| | | been activated |
| Field 22 | IsOnGround | Flag to indicate ground squat switch |
| | | is active |
| Field 23 | Aircraft Type Code | ADSB Data frame content |
| Field 24 | Aircraft Emitter | Characteristics of the ADSB unit/ |
| | Category | aircraft |
| Field 25 | RSSI value | Relative Signal Strength from SDR |

Exemplary message content is shown in Tables 2 and 3 below. Each message type contains different field content. in Tables 2 and 3. underlining or dashes indicate fields that are sent and blanks indicate fields for which null data is transmitted. MSG signals contain up to twenty-two fields and other message types contain up to ten fields.

TABLE 2

| | 1 | 2 | 3 | 4 | 5 | 6 | 7 | 8 | 9 | 10 |
|---|---|---|---|---|---|---|---|---|---|---|
| MSG1 | MT | TT | SID | AID | Hex | FID | DMG | TMG | DML | TML |
| MSG2 | — | — | — | — | — | — | — | — | — | — |
| MSG3 | — | — | — | — | — | — | — | — | — | — |
| MSG4 | — | — | — | — | — | — | — | — | — | — |
| MSG5 | — | — | — | — | — | — | — | — | — | — |
| MSG6 | — | — | — | — | — | — | — | — | — | — |
| MSG7 | — | — | — | — | — | — | — | — | — | — |
| MSG8 | — | — | — | — | — | — | — | — | — | — |

TABLE 3

| | 11 | 12 | 13 | 14 | 15 | 16 | 17 | 18 | 19 | 20 | 21 | 22 |
|---|---|---|---|---|---|---|---|---|---|---|---|---|
| MSG1 | CS | | | | | | | | | | | |
| MSG2 | | Alt | GS | Trk | Lat | Lon | | | | | | Gnd |
| MSG3 | | Alt | | | Lat | Lon | | | Alrt | Emer | SPI | Gnd |
| MSG4 | | | GS | Trk | | | VR | | | | | |
| MSG5 | | Alt | | | | | | | Alrt | | SPI | Gnd |
| MSG6 | | Alt | | | | | | Sq | Alrt | Emer | SPI | Gnd |
| MSG7 | | Alt | | | | | | | | | | Gnd |
| MSG8 | | | | | | | | | | | | Gnd |

The difficulty of accurately tracking an aircraft's position while it is close to, or on, the ground has led to problems with, among other things: collecting accurate data for airport master plans, Federal Aviation Administration (FAA) reporting and economic impact analysis; enabling near-real-time submission of aircraft operations data to FAA's Operational Network (OPSNET/OPSNET-R) at contract towered or non-towered airports; meeting Ground-Based. Detect and Avoid ((IBDAA) Requirements for unmanned aircraft system/unmanned aerial vehicle (UAS/UAV) operations; detecting unauthorized/illegal aircraft operations at unattended airfields; the ability to track or assess critical safety data such as how stable an approach to landing is; inability to detect incorrectly configured ADS-B installations; aircraft noise complaints and environmental impact; lack of market data for Fixed Base Operators (FBOs) at non-towered airports; inability for aircraft operators such as flight schools to determine “time in service” leading to higher expenditures per year on maintenance such as 100 hour inspections and decreased profitability; inconsistent collection of landing fees; high landing fees for small aircraft dissuading airport use and decreasing revenue for airport and airport's service providers; lack of forensic data. challenges to investigations of accidents/incidents at non-towered airports; property damage, injuries and fatalities caused by collisions on runway with other aircraft or wildlife; and inability to charge applicable state taxes due to lack of data/evidence that aircraft is in a state for more than a certain number of days over the course of a calendar year.

### SUMMARY

Aspects of the present disclosure provide a system, apparatus and method that provides a technical solution to the above problems and more.

Regarding the collection and production of accurate data, embodiments of the present disclosure collect ADS-B data broadcast by aircraft and optionally other vehicles, optionally collects other data from radar and other sensors, processes and even corrects the data as necessary, and fuses it with additional external data to provide rich, accurate, real-time vehicle and airport operations data. It will be appreciated that, for purposes of the present disclosure, the ADS-B data is an exemplary form of data employed as position data for an object such as an aircraft, and other forms of data are available and employable according to the present disclosure. In embodiments, the presently described system produces a super-set of information required for an airport master plan, FAA reporting and an economic impact analysis at the airport, regional, state or federal level. The present system differs from other approaches of determining aircraft operations as it leverages ADS-B signals broadcast from aircraft and other vehicles and corrects the data as necessary for a variety of beneficial outputs. It is currently not possible to use existing available ADS-B data sources for these purposes as they generally have coverage gaps at low altitudes, the raw data requires special processing and some critical information may be inaccurate, missing or misleading information. The present system, device and method also fuses ADS-B data received from aircraft with external data to facilitate reporting such as operations by type of aircraft, its size, and weight of aircraft, by registered owner and operations by local versus transient aircraft. Further, the present system, device and method can generate near real-time operations information for towered, non-towered and contract towered airports. In addition, the present system, device and method can transmit the aggregated and managed data to other systems, such as the FAA's OPSNET/OPSNET-R, which currently receive only manually collected information from contract towered airports on a. delayed and infrequent basis, and which receive no information from non-towered airports.

The present system, device and method can further operate so as to automatically collect real-time data, broadcast directly from vehicles such as aircraft at low or high altitudes to IAS/UAV operators to support GBDAA requirements on Beyond Visual Line of Sight (BVLoS) missions. As described elsewhere herein, the present system, device and method can detect low-altitude air traffic within coverage gaps of other ADS-B based systems and also to establish a geographically and/or temporally dynamic geofence volume around an operating UAS/UAV to facilitate the detection and avoidance of air traffic in the vicinity of the UAS/UAV. In various embodiments, the device and system disclosed herein is of a smaller form-factor, low power drawing, low cost and light-weight, and can be included in a mobile/portable UAS/UAV control center. As such, the present device, method and system can minimize the impact on other aviation activity near operating UAS/UAV while maintaining acceptable safety/risk levels.

In various embodiments, the presently disclosed system, device and method serves as an autonomous sentry that detects vehicle operations at unattended airfields via ADS-B broadcast, radar or other sensors in real-time and, subsequently, transmits alerts via digital messages, text message, email, or optionally an audible/visual alarm. The present system can also exploit ADS-B broadcast, radar or other sensors to detect unauthorized/illegal vehicle operations. Further, the small profile according to various embodiments deters its identification as a security device.

Embodiments of the present disclosure can also assess the stability of aircraft on their landing approach based on speed along with vertical and lateral deviations from the optimal, stable, approach trajectory. Such assessment can augment safety training initiatives such as FAA seminars and instructor-led training and assess their effectiveness, for example. It can be a valuable data source to inform the development of aviation regulation, policy and guidance.

Embodiments of the present disclosure can further detect anomalies in ADS-B air/ground state broadcasts which may be caused by dirty/faulty squat switches on an aircraft, incorrect configuration of the equipment or an error which occurred during manufacturing of an aircraft's ADS-B equipment. Such anomaly detection can assist local avionics installation/repair shops in identifying problem aircraft and testing installations/repairs. in various embodiments, the system uniquely identifies issues in the air/ground status broadcast in ADS-B data from aircraft. Currently, there is no accurate method to identify or test system misconfiguration or malfunction, which can lead to improper air/ground status broadcasts. Further, current FAA installation certification testing requirements overlook the testing of this certification requirement.

Embodiments of the system, device and method as disclosed herein can further detect the penetration by an aircraft of a geofence volume configured to support a noise sensitive area and optionally generate a near-real-time alert or detected event notification to notify individuals such as airport managers, for example, if an aircraft impinged on related volume thresholds. Such alerts, notifications and/or reports can contain detailed information about the aircraft along with owner information and address. Notifications may be used in asserting fines against violators and/or issuing warnings based upon determined identities of the operators of such aircraft. The three-dimensional geofence configuration can be time-based such as, for example, between the hours of 10 pm and 6 am, In this respect, it will be appreciated that the geofence configuration can include a fourth dimension of time. Other noise complaint systems may employ aural sensors to measure noise, but such sensors do not reliably associate the source of the noise to an aircraft. Further, if the noise is associated with an aircraft, other systems do not have the capability of rapidly and easily identifying the responsible aircraft or its owner. The presently described system can monitor time-based geofence volumes and, if that volume is penetrated, accurately identify the responsible aircraft and its registered owner. Further, the system can respond differently if an aircraft penetrating the geofence of a noise sensitive area is a small plane versus a noisier jet-powered aircraft or helicopter.

Among other advantages, the presently disclosed embodiments deliver rich information about aircraft using a given airport, including make/model, type of engine(s), and number of passenger seats. In some embodiments, the number of actual passengers can be accessed from the FAA or other sources as appropriate. Individual airports can use this data to attract fixed-base operators (FBOs) and other service providers (e.g., tenants). The system can provide reports to FBOs such as the types of aircraft and vehicles operating out of an airport, operations by locally-based versus itinerant aircraft, the types of fuel used by the aircraft operating out of an airport and the number of passengers each aircraft can carry.

In various embodiments, the present system, device and method calculate accurate time in service, from take-off to landing, for an aircraft. Currently almost all operators are using a Hobbs meter or tachometer time to calculate flight-hour based inspection times, such as a 100-hour inspection times. These time measurements include time on the ground. Using the presently disclosed embodiments can result in fewer 100-hour inspections per year and. significant related cost savings.

In addition to the above, landing fees can be automatically calculated for each landing aircraft according to the present disclosure, and landing fee invoices can be automatically generated and sent to the registered aircraft owner, Past systems employing cameras have questionable accuracy, variable performance due to the effect of environmental conditions on the cameras and other factors and are significantly more expensive. Landing fees can be assigned per aircraft type, by aircraft weight, number of seats, and other factors, whereby smaller aircraft can be charged less than larger aircraft or locally based aircraft can avoid being charged, for example.

As aircraft position data is collected and stored over time, the data can be made available to investigators to assist with the reconstruction of events prior to an incident or accident. By focusing on low-altitude operations on and near airports, where most incidents and accidents occur, embodiments of the present disclosure collect more precise data than alternative means such as relying on witness accounts or finding a security camera that may be pointed to cover a subset of the area of interest to an investigator or legal professional.

Among other advantages, existing and anticipated runway obstructions associated with vehicles, aircraft and wildlife can be detected according to the present disclosure. The present system can produce real-time notifications of an obstruction on or near a runway, for example, by analyzing data from ADS-B receivers, radar, LiDAR and/or wildlife cameras and subsequently transmitting an obstruction present/detected event notification message. Such messages and other notifications as described herein can be communicated over a public or private network, or via cellular communications, for example, to users having a suitable communications device such as a device as described in connection with Fig. I and elsewhere herein. However, it will be appreciated that there may be safety, technological and regulatory limitations to notifying a pilot of the existence of an imminent safety hazard while the pilot is in the cockpit of an airplane. For example, as mobile communications devices are not intended to be operational in the air (or in “airplane mode”), it may not be feasible to send a notification to a pilot by traditional cellular network communications. As such, to the extent that the embodiments of the present disclosure may be recognized as an ADS-B enabled device and able to incorporate ADS-B Out transmissions, such transmissions can be used to notify pilots of potential dangers. To the extent that ADS-B Out transmissions are unavailable, programming according to the present disclosure may be operable by a mobile communications device used by a pilot to periodically “look” for a WiFi signal from a designated WiFi network name. As a method of “signaling” the pilot, the present system can Key (turn off and on) the WiFi signal with a certain pattern or “rate” that the software application on the mobile communications device would detect and then would be able to sound an alarm or otherwise notify the pilot in real time using the mobile communications device screen, speakers and/or haptic output component(s). It will be appreciated that other variations on this approach can incorporate another existing radio signal that may “key” or send an audible message with the warning. For example, an airport's existing Automated Weather Observing System (AWOS) station frequency can be employed (if the airport has an AWOS) whereby the present system can “punch in” to the AWOS audible weather with a human speech warning/alarm that the pilot would hear if they are listening to the AWOS weather broadcast. As a further alternative, notifications produced by the presently described system can be transmitted via a low power FM frequency for receipt by mobile communications devices having the ability to receive FM radio stations. Programming (e.g., a smartphone app) associated with the present disclosure can be operated by the mobile communications device to pick up the “signal” and relay the notification to the pilot.

In various embodiments, the presently disclosed system can generate reports containing ground time for aircraft located in specified locations, such as a state, over the course of a period of time, which can assist with compliance monitoring according to specific jurisdictional laws and rules. Further, the presently disclosed system can monitor vehicles in and around airports to assess performance. For example, if an airport runway is to be swept clear of foreign object debris (FOD) once every defined time period (e.g., two hours), embodiments of the present disclosure can employ and ADS-B transponder on vehicles such as trucks that are employed to perform the stated tasks. If the truck is determined to have traveled across the full runway at least once during the established time period, the present system can notate through communicating a message or logging the details of the tracked compliant vehicle behavior. Conversely, if the assigned truck has not performed to the required standard, message communications and/or data logging can reflect such non-compliance and appropriate remedial action can be undertaken.

In various embodiments, a low power radar simulator and a low power ADS-B transmitter can be employed. The radar simulator can produce a secondary surveillance radar (SSR) signal to cause vehicles in the vicinity and on the ground to reply with an ADS-B surveillance ID message containing the vehicle's transponder code. Ordinarily, an vehicle's ADS-B system only sends an ADS-B surveillance ID message when it is pinged or interrogated by a true SSR signal from an FAA SSR radar system as the vehicle is operated in the transmission range, which is typically 3,000 feet above ground level of an operating FAA SSR. The radar simulator according to the present disclosure can be operated below this level and can in various embodiments capture the vehicle's transponder code on the ground and before takeoff, or at least when it is dose to the airport.

The ADS-B transmitter can be employed to send a standard ADS-B message for end-to-end test messaging of a complete system according to the present disclosure in real time. During late night and/or early morning, there are very few vehicles in some of the locations in the US. Where there are no vehicles sending ADS-B messages, embodiments of the present disclosure have no vehicle detections and no way to distinguish if there are truly no vehicles sending ADS-B messages or that there may potentially be a failure in the antenna, cabling or other aspects of the present disclosure such that it appears the system and/or device is “running” but no vehicles are being detected. By providing an ADS-B message transmitter with the ability to send a test message out, this test message would be received and processed to provide full end-to-end validation that all components of the system are in place and operating appropriately.

The presently disclosed system may be used in a wide variety of environments to support a wide variety of external systems and operations, including, for example: aircraft geofence penetration detection systems; aircraft operations counter and analysis systems; airport and aviation economic impact analysis systems; airport ground movement sensing, analysis, reporting systems; airport master plan support systems; aviation safety systems; avionics installation testing systems; data collection systems; environmental analysis systems; FAA OPSNET/OPSNET-R; Fixed Base Operator (FBO) systems, flight school cost reduction systems; flight school systems; Ground Based Detect and Avoid system (GBDAA) for UAS operations; Internet of Things (LOT) sensor platforms; landing fee systems/dynamic landing fee systems; near real-time OPSNET-R data feed for contract towered airports; noise monitoring systems; post-accident/incident forensic analysis systems; runway object detection and notification systems; runway sensor and data communications access nodes; runway surveillance and security systems; sensor platforms; state-wide analysis of general aviation impacts, tax collection support systems; identifying aircraft using the wrong transponder code in Special Flight Mules areas and wildlife detection.

Further aspects are apparent from the description and drawings herein. The computing system(s) associated with the present disclosure can include one or more processors executing instructions stored in one or more memory modules to carry out the requested and required functions disclosed herein.

### BRIEF DESCRIPTION OF THE DRAWINGS

FIG. 1 is an example schematic diagram of one embodiment associated with the present disclosure, showing an overall system incorporating external components in communication with a central host component of the present disclosure.

FIGS. 2, 3A and 3B are example schematic diagrams illustrating components of a detection unit in accordance with aspects of the present disclosure.

FIGS. 4 and 5 are illustrations of different aircraft operations that may be assessed in accordance with the present disclosure.

FIGS. 6 through 8 illustrate example user interfaces representing output types in accordance with the present disclosure.

FIG. 9 is a schematic diagram of an AGVA geofence in accordance with aspects of the present disclosure.

FIG. 10 is a schematic diagram of elements and actions of a remote server in accordance with the aspects of the present disclosure.

FIG. 11 illustrates an exemplary custom report in tabular format in accordance with the aspects of the present disclosure.

FIGS. 12 through 17 are exemplary flow diagrams illustrating processes in accordance with aspects of the present disclosure.

FIG. 18 shows exemplary operation filters in accordance with aspects of the present disclosure.

FIG. 19 shows a schematic diagram associated with runway determination in accordance with aspects of the present disclosure.

### DETAILED DESCRIPTION OF THE PREFERRED EMBODIMENTS

The presently disclosed subject matter now will be described more fully hereinafter with reference to the accompanying drawings, in which some, but not all embodiments of the presently disclosed subject matter are shown, Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Example embodiments such as disclosed herein can incorporate a host, local device and/or controller having a processor and an associated memory storing instructions that, when executed by the processor, cause the processor to perform operations as described herein. It will be appreciated that reference to “a”, “an” or other indefinite article in the present disclosure encompasses one or more than one of the described element. Thus, for example, reference to a processor encompasses one or more processors, reference to a memory encompasses one or more memories, reference to a radio encompasses one or more radios and so forth.

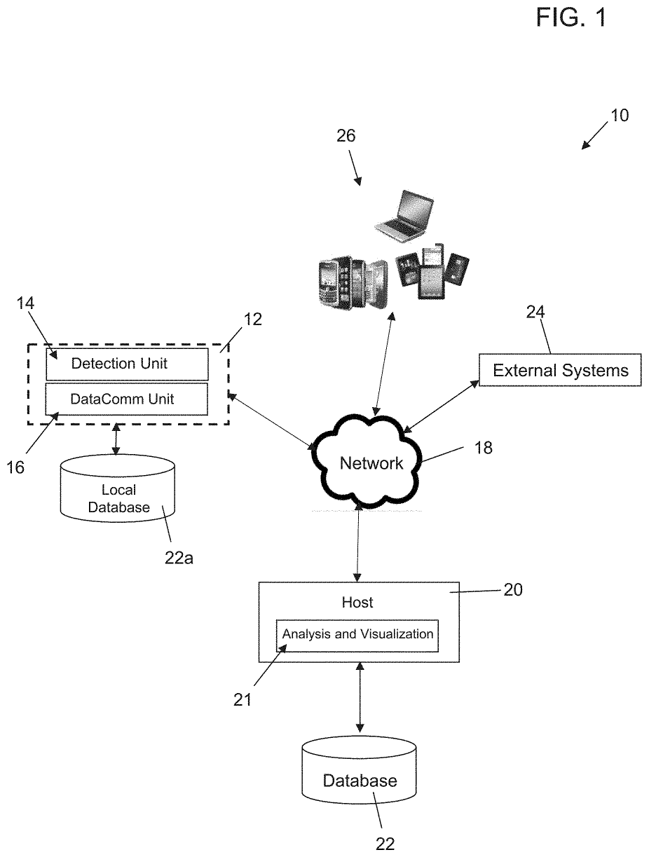

FIG. 1 is a schematic diagram illustrating an exemplary system 10 for facilitating data collection, verification, processing, maintenance and related transaction, functional and. monitoring activities in accordance with various network-enabled and/or online embodiments of the present disclosure. As shown therein, embodiments of the present disclosure can include various components and/or modules that can be implemented in hardware, software, firmware, or combinations thereof. FIG. 1 illustrates an exemplary high-level network 18 with exemplary user computing devices 26 and external computer systems 24 that can interact with system 10. In various embodiments, users can access a remote host 20 using client computing devices, such as personal computers (PCs), tablet computers, laptops, mobile communications devices (including smartphones), personal digital assistants (PDAs) and other forms, for example. An airport monitoring subsystem or IOT sensor subsystem 12 is shown in dashed lines, and this subsystem 12 is in communication with the remote host 20 via the network 18. The subsystem 12 can include a detection unit 14 and a DataComm unit 16 as will be described in greater detail elsewhere herein. A local database 22a can also be provided as part of and/or in communication with the IOT subsystem 12. External systems 24 can include computing systems such as an FAA website or information repository, for example. The remote host 20 can include an analysis and visualization engine 21 and is in communication with a local 22a and remote database 22.

It will be appreciated that the system of the present disclosure can incorporate necessary processing power and memory for storing data and programming that can be employed by the processor to carry out the functions and communications necessary to facilitate the processes and functionalities described herein. One or more monitors or display devices can be provided with the computing devices 26 as will be understood in the art. In addition to display devices, the computing devices 26 can also include other peripheral output devices, which may be connected through an output peripheral interface. The computing device(s) implementing the host system 20 of the present disclosure may operate in a networked environment using logical connections to one or more remote computers, the remote computers typically including many or all of the elements described above. A private network, or a publicly available network such as the Internet, for example, can act as network 18 providing interconnectivity for various devices to communicate with one another.

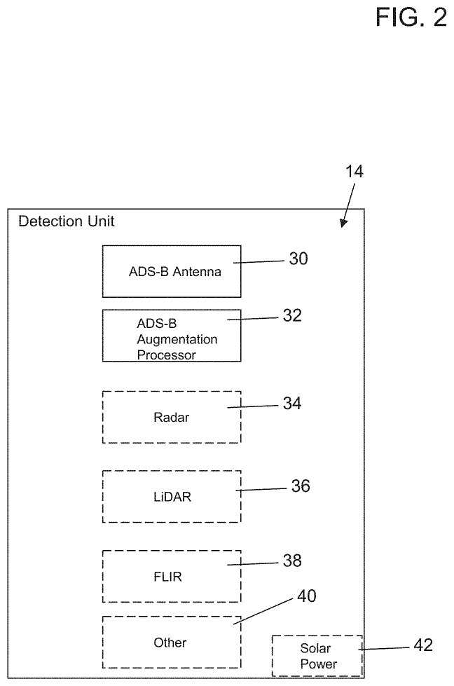

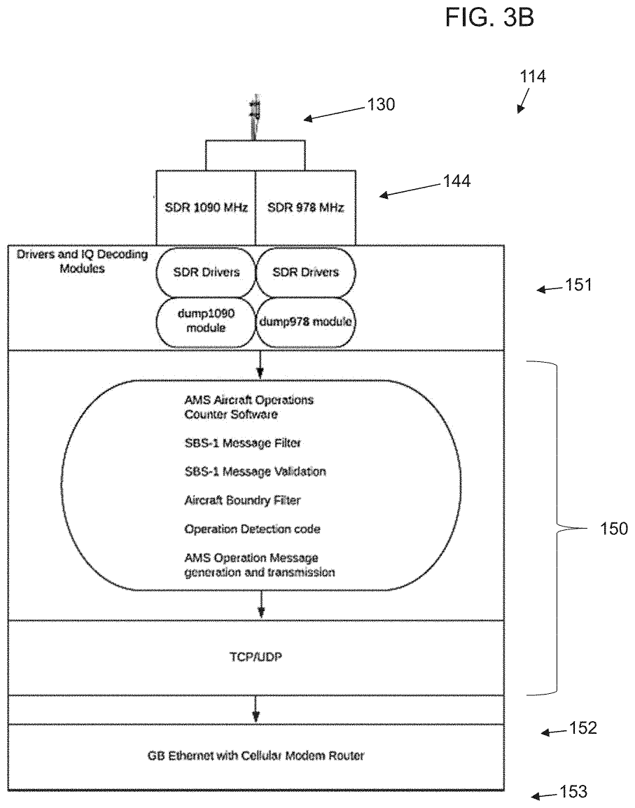

As shown in FIG. 2, the detection unit 14 of the IOT subsystem 12 can include one or more sensors and other components, including an ADS-B antenna 30, an ADS-B augmentation processor 32. a radar sensor 34, a LiDAR sensor 36, a forward looking infrared (FLIR) sensor 38 and other sensors 40 such as wildlife sensors, for example. Sensors 34, 36, 38 and 40 are shown in dashed lines in FIG. 4 as such sensors are optional in accordance with embodiments of the present disclosure. An optional solar power source 42 can also be provided as part of the detection unit 14, which enables detection unit 14 to be self-sufficient for power to operate the one or more sensors, antenna and processor when installed at an airport, for example.

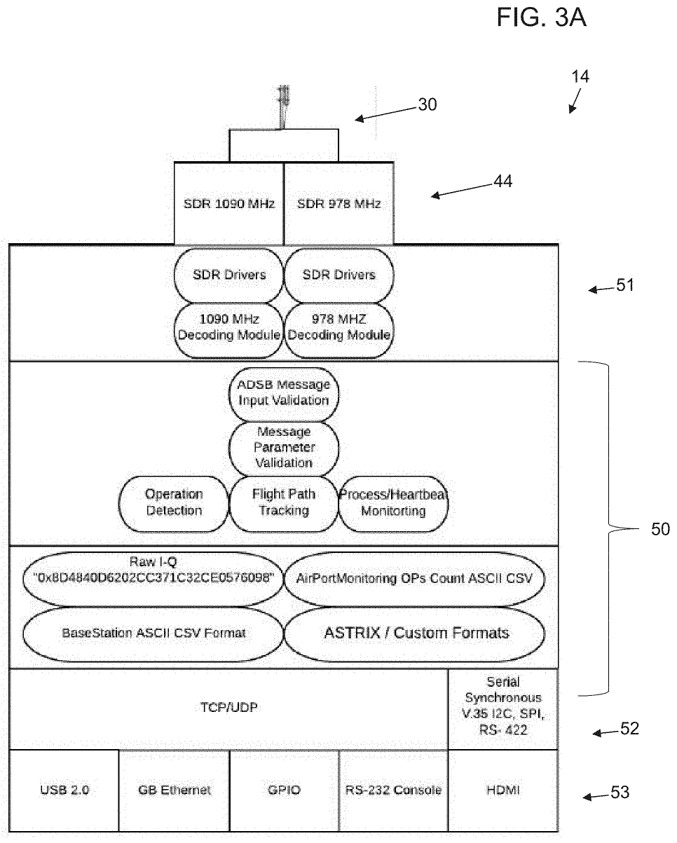

In various embodiments such as shown in FIG. 3A, the detection unit 14 can include one or more ADS-B radio receivers 44 and antenna(s) 30, and a single board computer or detection unit processor 50 running the operation detection, message format and transmission software modules. The radio receivers 44 can be Software Defined Radios (SDRs), which are hardware devices that can be connected to antenna 30 and configured to receive ADS-B broadcasts from aircraft on 1090 MHz or 978 MHz, for example. Appropriate drivers and IQ decoding modules 51, transport protocol 52 and input/output ports 53 are also shown. The computer 50 can include middleware components for performing functions such as ADS-B message input validation, message parameter validation, operation detection, flight path tracking and process/heartbeat monitoring, for example. The detection unit processor 50 can execute programs stored in a local memory, for example, including ADS-B message format modules such as, for example, Raw I-Q module, Basestation ASCII CSV format module, an Ops Count ASCII CSV module and ASTRIX/custom format module.

FIG. 3B shows an alternative embodiment of detection unit 114 with antenna(s) 130, radio receiver(s) 144, computer 150, driver(s) and decoding module(s) 151, transport protocol 152 and input/output ports 153.

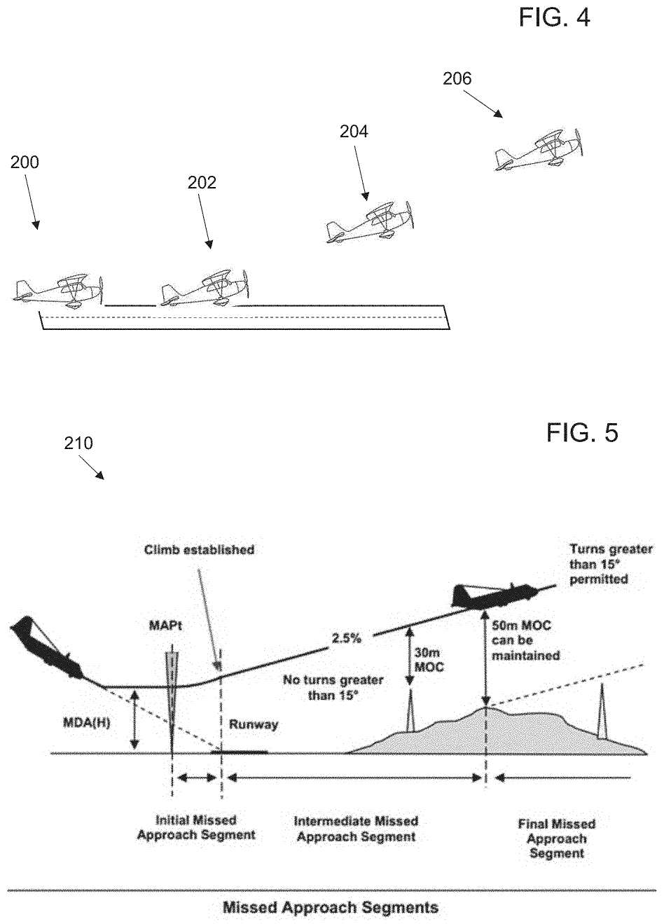

In detecting airport or aircraft operations, as shown in FIGS. 4 and 5, it will be appreciated that a “takeoff” can occur when an aircraft starts at an airport and becomes airborne. As shown in FIG. 4, for example, the aircraft travels down the runway at 200, rotates at velocity Vx as shown at 202, climbs at velocity Vx as shown at 204 and continues climbing at velocity Vy as shown at 206, whereupon retractable landing gear can be retracted.

A “landing” can occur when a previously airborne aircraft enters an airport geofence volume area (AGVA) and lands at the airport. A “flyover” is illustrated at 210 in FIG. 5 and can occur when an aircraft is airborne, enters the AGVA, flies towards and over the runway but does not land. it will be appreciated that the AGVA can be considered as a “volume” of airspace that is used as a boundary to determine if an aircraft's position is of interest to track and process. it will further be appreciated that an AGVA may include a time component, such that a defined geofence volume may be considered as existing during specific time periods (e.g., daylight hours) and not existing during other specific time periods (e.g., night hours). This space can also be referred to as a “geofence” and the geofence can be created by the remote host 20 and/or detection unit processor 50 to accommodate any shape, volume, time and location.

In various embodiments, each SDR 44 is connected to an antenna 30 that is mounted outside in a location that will allow the ADS-B signals from a given vehicle to be received. In the case of an aircraft, the ADS-B signals can be received as the aircraft takes off or lands. in some cases, this may mean located the antenna 30 at a height no greater than six feet to ensure line of sight with the aircraft/vehicles ADS-B transponder antenna under an aircraft wing. The connection of the antenna to the SDR can use 50-ohm coaxial cable, for example. The SDRs 44 can be configured by a software program running in the computing device. In various embodiments, the configuration tunes the SDRs 44 to the correct frequency (1090 Mhz and 978 Mhz) and then passes any data from the SDRs 44 to another software program that decodes the raw digital data into its respective values and then passes the decoded message (e.g., in the form of a comma-delimited string called the SBS format) to a “socket” (IP address and port number) which allows other programs the ability to receive the decoded ADS-B Message in the SBS format. An exemplary decoded message in SBS format is shown below. MSG,3,5,211,4CA2D6,10057,2008/11/28,14:53:50,594, 2008/11/28,14:58:51.153,, 37000,,,51.45735, −1.02826,−0,0,0,0

The detection unit 14 can be located near or at an airport, for example. As further shown in FIG. 1, the system includes an airport DataComm unit 16 which can also be located near or at an airport. The DataComm unit 16 can include a data modem/router connected to the detection unit 14 and provides a connection to a network 18, thereby allowing the detected operations to be sent to the remote server 20 and a local or remote database 22a. It will be appreciated that the DataComm unit 16 located at the airport within the IOT subsystem 12 can be a combination cellular data modem and TCP/IP router designed for remote data monitoring and accessibility. It can contain a built in GPS receiver, and can be provided with added security features such as an encrypted network and an optional secondary or “fall back” network. The DataComm unit 16 provides a connection to the network 18 for sending “operation event messages” from the detection unit 14 to the remote server 20 for further processing of the operation event message. In various embodiments, the DataComm unit 16 also provides access to the NWS ADDS server on a regular basis (e.g., every ten minutes as one means of obtaining the current airport weather observation report called a METAR. The METAR is issued every hour and is valid for one hour. It contains the following weather “elements”:
Type of report
ICAO Weather station Identifier
Forecast Times and Report Modifiers
Wind (Direction, speed and gusts)
Visibility. Obstructions to Vision
Runway Visual Range
Present Weather
Sky Conditions (Cloud Heights and % coverage of sky)
Temperature/Dew Point
Altimeter (Barometric Pressure at the airport)
Remarks and Weather Flight Rules Category (VFR, MVFR, IFR, LIFR)

Several of these elements can be used by the detection unit 14 to provide various derived values. For example barometric pressure used in computing the airport pressure altitude. Obtaining/determining current airport barometric pressure (either from external sources or a locally connected sensor) is required as the ADS-B data from an aircraft includes both geometric and barometric altitudes. Wind speed and direction are used to compute the effective wind speed on the runway to allow the detection unit to calculate the aircrafts effective airspeed which is not provided in the ADS-B message but is used when detecting Take-off and Landing Operations. The FAA Flight rules category is included in the “operation event message” to provide a context as to the Visibility conditions that were occurring during the operation.

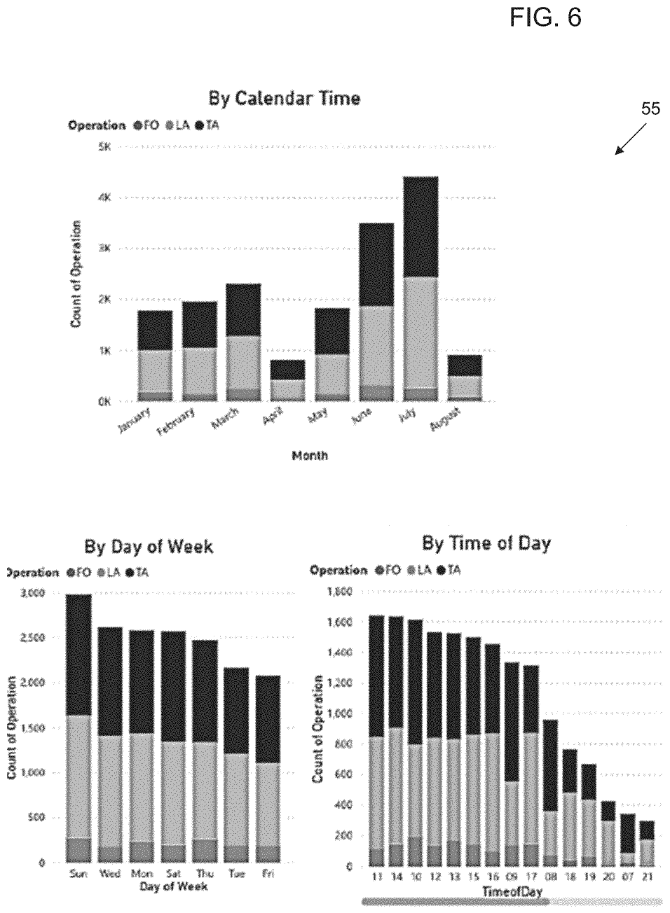

The remote server 20 can conduct operations processing and provide access to database 22a located on the IOT subsystem or database 22. In the event of a communications failure the IOT Subsystem can store the operation event messages on database 22a and once communications is restored the remote server 20 can transfer the operations captured on database 22a and update the Remote Server Database 22. In various embodiments, the remote server 20 receives operations from the detection unit 14, applies filtering and operation validation and inputs the operation into database 22 and/or local database 22a. It will be appreciated that a data visualization dashboard such as produced by component 21 can also be provided as part of a user interface. In various embodiments, the user interface is accessed via a computing device 26 such as a monitor or portable communications device. The operations that are stored in the database 22 can optionally be accessed by a third party “data visualization” tool such as Microsoft PowerBI™ and displayed on a user interface, for example or transmitted to an external system for visualization or further analysis/processing. Exemplary user interfaces 55, 56, 57 illustrating output according to the present disclosure are shown in FIGS. 6, 7 and 8.

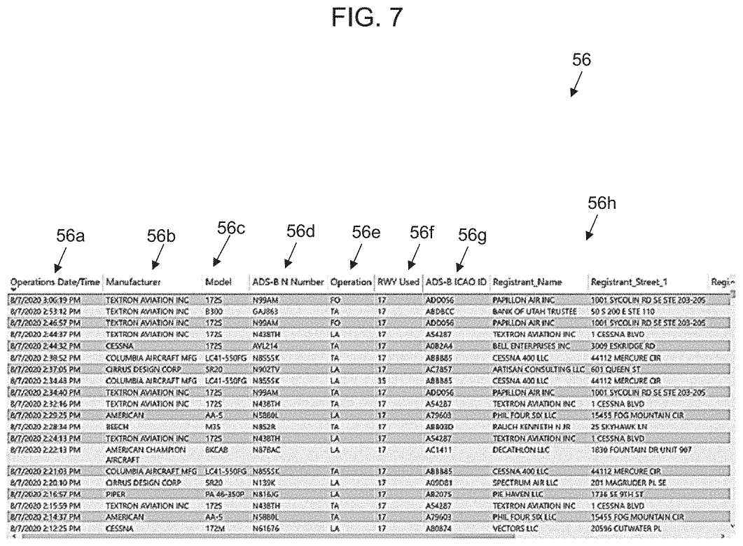

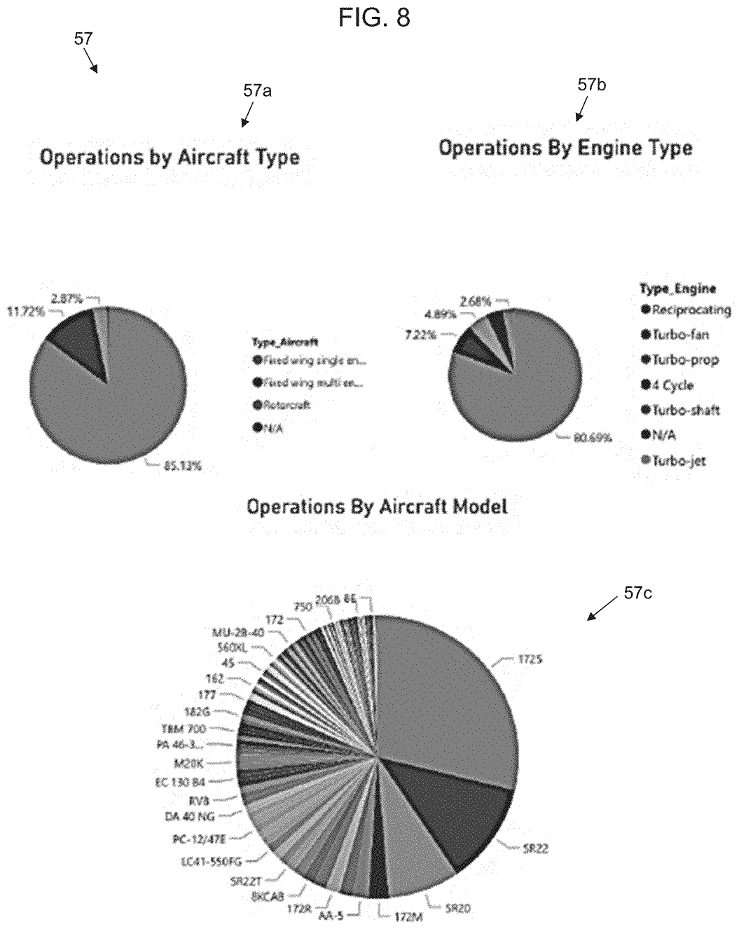

As shown in FIG. 6, for example, takeoff, landing and flyover operations can be presented in user interface 55 according to calendar time, day of week and time of day for a given airport. As shown in FIG. 7, details of various operations and the aircraft involved can be presented in user interface 56 in organized form including, for example, date/time of the operation 56a, manufacturer of the aircraft 56b, model of the aircraft 56c, ADS-B-N number 56d, operation involved 56e, runway used 56f, ADS-B-ICAO ID 56g, and the aircraft registrant's name and address 56h. As shown in FIG. 8, details of operations can be recorded and presented in user interface 57, including operations by aircraft type 57a, operations by aircraft engine 57b and operations by aircraft manufacturer 57c.

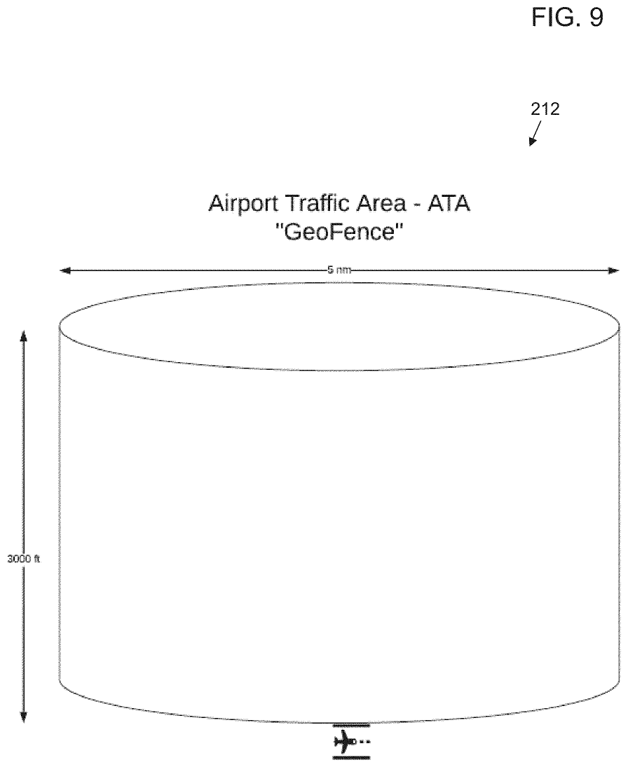

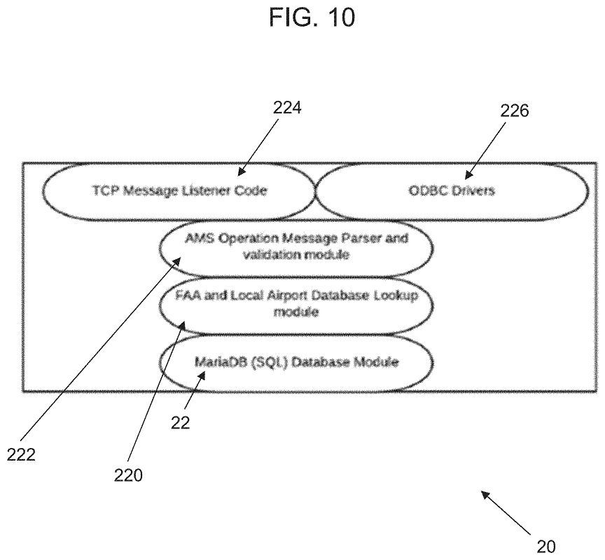

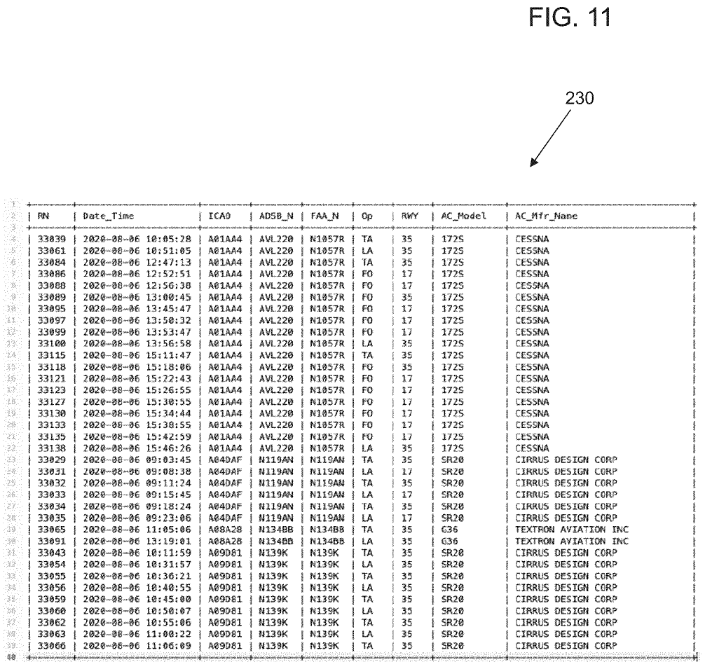

In various embodiments (see diagram 212 in FIG. 9, for example), the detection unit 14 can receive ADS-B transmissions from aircraft within a defined volume (e.g., five statute miles from the airport center extending from the surface up to, but not including, an altitude of 3,000 feet above the elevation of the airport), then track (record) the aircraft's ADS-B data including position (latitude and longitude), altitude, groundspeed, track, transponder code, the aircraft's ICAO (four letter) ID code, the aircraft's call sign/tail number and on ground status flag until enough data has been collected to determine an aircraft operation has occurred. Such an aircraft operation can be, for example, a “Landing”, a “Take Off”, a “Fly Over or Missed Approach”, a “Transiting Aircraft” that is transiting the airspace within the volume being monitored, a runway incursion, an anticipated runway incursion, a taxiing movement, a stable approach, a spot landing, a traffic pattern movement, a “Touch and Go” movement or a “Stop and Go” movement. The aircraft operation can also include an identification of which runway was used for the operation. Embodiments of the present disclosure can also employ the detection unit to detect ADS-B transmissions from other vehicles. Detected aircraft operations (events) can be transmitted via network 18 such as the internet to a remote server 20 that can query an external system 24 such as a public FAA database using the received aircraft ICAO ID code and acquire the aircraft registration number, registered owner, aircraft type, aircraft manufacturer, aircraft model, engine type, gross weight, number of seats and other parameters. In addition to the ADS-B and FAA data, the remote server 20 can query another external system 24 such as an airport's own database to obtain the aircraft's airport home base and determine if the aircraft is based at the “home” airport or is an “itinerant/visitor” to the airport. In various embodiments, all of the ADS-B, FAA and airport home based aircraft data can be merged into a single data record and stored in database 22 which can be a Relational Database Management System (RDBMS), for example. All aircraft operations stored in the database 22 can then be visualized using a graphical dashboard-type presentation accessible via analysis and visualization component 21. In addition, all data in the database can be accessed/queried to produce custom datasets and/or reports based on the need and format. FIG. 10 provides a schematic diagram illustrating elements of remote server 20 and its operations, including database 22 for storage, FAA and local airport database lookup module 220, AMS operation message parser and validation module 222, TCP Message Listener programming 224 and ODBC drivers 226. FIG. 11 illustrates an exemplary custom report 230 in tabular format. Tracked operational details of other vehicles can also be stored and used for notifications as described elsewhere herein.

In various aspects as described elsewhere herein, the IOT subsystem 12 can be considered an autonomous IOT sensor platform or system and can be located onsite at an airport, for example. The IOT subsystem 12 can be powered externally or via solar panels (e.g., 42 in FIG. 2) that facilitate the connection of sensors to collect and transmit data via wired, wireless or cellular networks. In various embodiments, such as shown in FIG. 3A, for example, the ICT subsystem 12 can include one or more Software Defined Radios (SDRs) 44 connected to antenna 30 and configured to receive ADS-B broadcasts from aircraft on 1090 MHz and 978 MHz, for example. The antenna 30 can be positioned to receive signals broadcast from aircraft via a direct line of sight. It will be appreciated that most ADS-B transmitters on aircraft have their antenna on the bottom of the aircraft. In order for the antenna 30 to have line of sight with the bottom of the aircraft at all times, the antenna 30 must be have a clear line of sight low enough to avoid being blocked by an appendage, such as a wing. More than one antenna 30 can be used if necessary to meet the line of sight requirements in order to receive the ADS-B signal anywhere on the airport. In various embodiments, an optional serial port connection to radar sensors can be configured to detect movement on runways. Optionally, other sensors can be employed as noted elsewhere herein for other functions, such as detecting wildlife on or near a runway, for example.

In various embodiments, the 101 subsystem 12 incorporates processing power, memory and software (e.g., embedded software)) that can establish one or more geofence volumes such as airport traffic area, area around runway, noise sensitive area or other area of interest such as taxiways, ramps, helipads etc; support one or more time-based dynamic geofence(s) that can be used for the detection of aircraft within the volume at certain times (e.g., 10 pm to 6 am); instantiate one or more geographically dynamic geofence(s) that can be used as a defined volume of airspace surrounding one or more UAS/UAV vehicles; decode ADS-B broadcasts from aircraft on 1090 MHz and 978 MHz; identify aircraft as within or external to one or more geofence volumes; analyze the flight path of aircraft; process and filter raw data received to determine if aircraft conducted a take-off, landing or fly-over (go-around/missed approach); identify suspected mis-configured ADS-B installations in aircraft process and filter raw data received for other purposes such as flight training support, safety analysis, research and development support and/or forensic (post-accident/incident) evidence; store and forward raw and processed data to external system for further processing and/or visualization via wired, wireless or cellular network; and generate and transmit alerts and notifications. Such alerts can be based on configurable event parameters such as aircraft identification, aircraft location, aircraft transponder squawk code and/or time, for example. For purposes of the present disclosure, a detected event notification can include a communication to electronic devices such as logging one or more data elements in a database. A detected event notification can further include a communication to a computing device such as a mobile communications device, remote server, or runway safety lighting controller for example. Such a notification can be a warning of potentially dangerous activity such as an unstable approach by an aircraft, a violation of a restriction such as a noise restriction, a tracking of a consequential action such as an aircraft landing that incurs a landing fee, and other real time notifications.

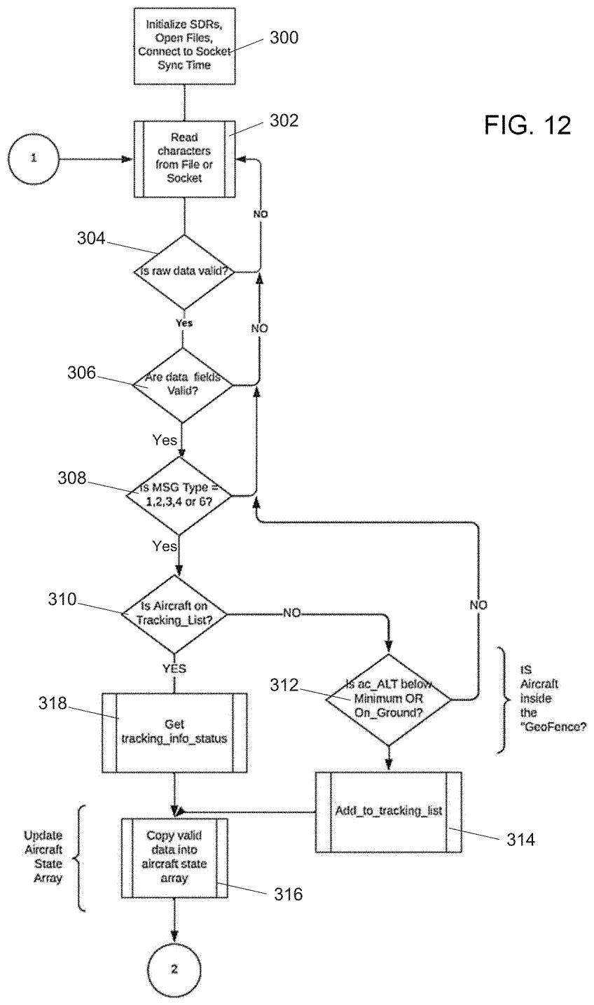

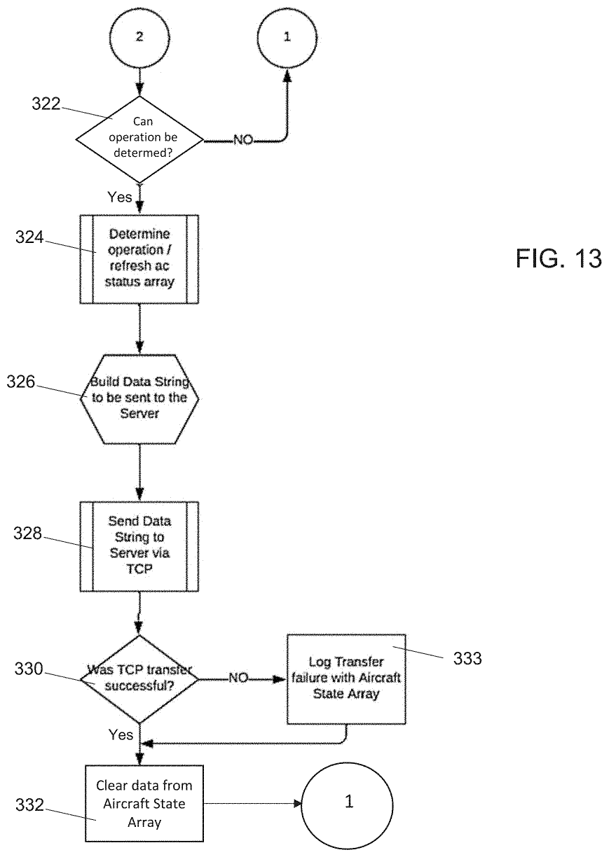

Various data filtering approaches can be employed according to embodiments of the present disclosure. For example, FIGS. 12 and 13 show an exemplary ADS-B flowchart, As shown in FIG. 12, SDRs are initialized, files are opened, the system is connected to a socket and time is synchronized as at 300. As at 302, characters are read from a file or socket. The method then checks to see if the raw data is valid as at 304, if the data fields are valid as at 306 and if the sub-message type is 1, 2, 3, 4 or 6 as at 308. If the answer to any of these conditions is “no”, the process returns to reading the file and/or socket at 302. If the answer to these conditions is “yes”, then the method checks if the aircraft is on the tracking list as at 310. If not, and if the altitude for the aircraft is not below a minimum, within a defined distance from the airport, and/or on the ground as checked at 312 (any and all of which can be considered to be within a defined geofence), then the method returns to reading the file and/or socket at 302. If not, and if the altitude for the aircraft is below a minimum, within a defined distance from the airport, and/or on the ground as at 312, the method adds the aircraft to tracking as at 314 and copies valid data into the aircraft state array as at 316 before proceeding to encircled notation “2” in FIG. 13. It will be appreciated that other conditions can be employed instead of those addressed above or specifically referenced in the drawings. For example, the point-of-interest within a geofence volume may not be an airport but could be a neighborhood where noise sensitivity is an issue, an area around a moving drone/UAV/UAS or other use case, for example. As further shown in FIG. 12, if the aircraft is on the tracking list, tracking info status data is obtained as at 318, the method copies valid data into the aircraft state array as at 316 and then proceeds to encircled notation “2” in FIG. 13.

As shown in FIG. 13, the system evaluates whether the aircraft operation can be determined as at 322. and if not, returns to the beginning of the method in FIG. 12 noted by encircled notation “1”. If so, the aircraft operation is determined as at 324. As part of determining the aircraft operation, embodiments of the system and method as described herein can use data collected in the aircraft state array, determine the aircraft operation (e.g., takeoff, landing, flyover) from initial and final values of one or more of the following parameters: message number, message time, airborne/ground status, altitude, latitude/longitude, on ground flag, maximum and minimum distance from an airport reference point, ground speed, vertical rate, track, transponder code, AP pressure altitude and emitter code. Once the aircraft operation is determined, a data string can be built as at 326 to be sent to the remote server (20 in FIG. 1) and is then sent to the remote server as at 328, by TCP protocol and store the data string (e.g., on the local database 22a in FIG. 1) according to certain embodiments of the present disclosure. The system and method then determine if the transfer has been successful as at 330 and if so, the data is cleared from the aircraft state array as at 332 and the system and method return to the beginning of the method as noted by encircled notation “1” in FIG. 12. If the TCP transfer is not successful as determined at 330, the transfer failure is logged as at 333.

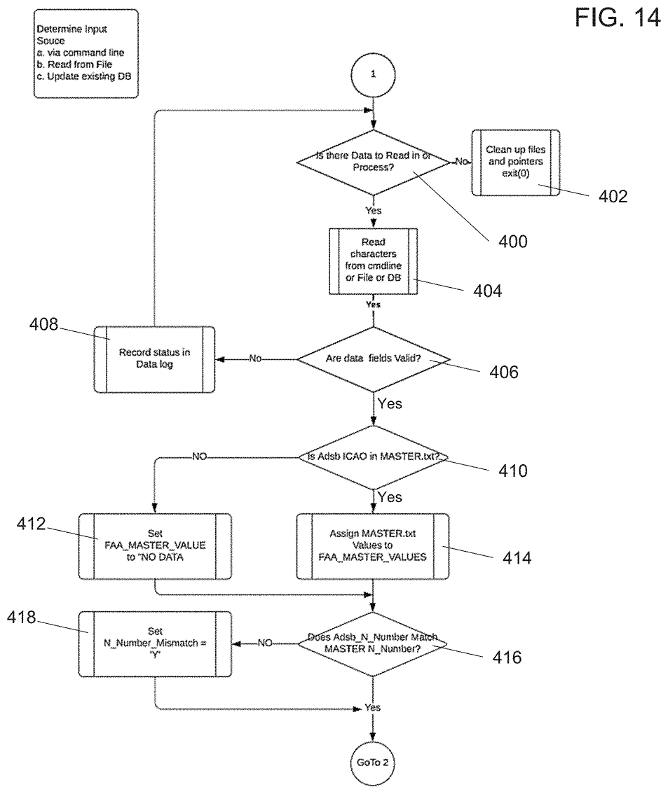

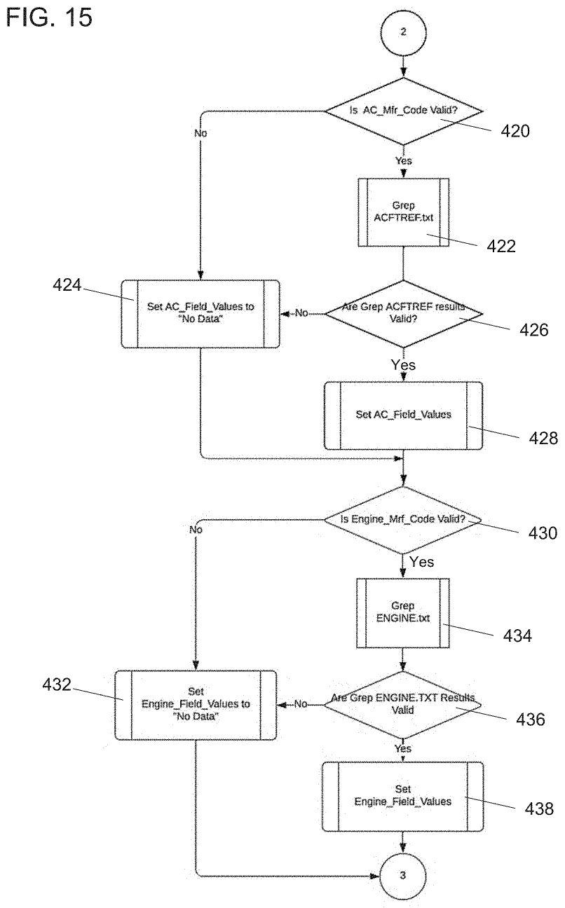

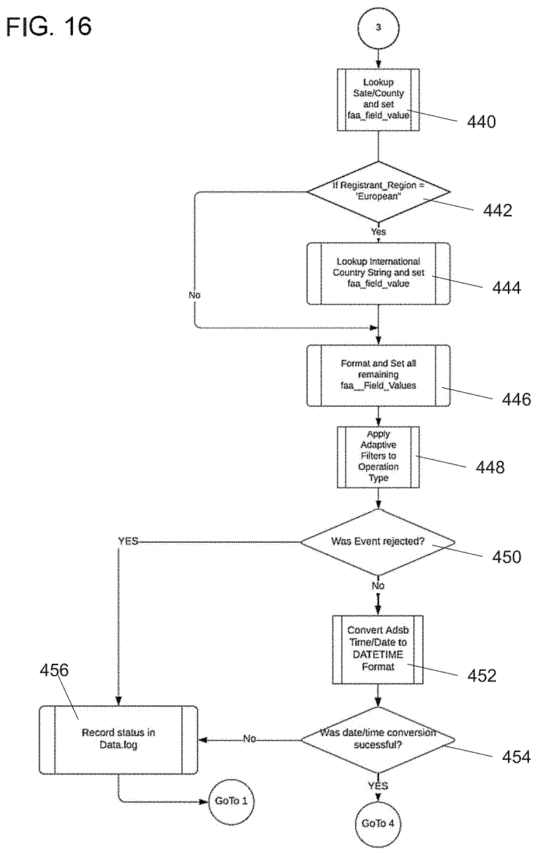

Additional methods according to additional embodiments of the present disclosure are shown in FIGS. 14 through 17, which can be considered to represent an ADS-B database server flowchart in accordance with various embodiments of the present disclosure. For example, with reference to FIGS. 14 through 17, the system determines if there is data to read in or process as at 400 and if not, cleans up files and pointers as at 402. If so, characters are read from a file or database as at 404, and a check is made to see if the data fields are valid as at 406. If not, the status is recorded in data log as at 408. If so, a determination is made as to whether the ADS-B-ICAO is in a designated text file as at 410. If not, the FAA Master Value is set to no data as at 412. If so, the text file values are assigned to a master set such as can be called FAA_Master_Values, for example. Regardless of whether the ADS-B-ICAO is in a designated text file, the system then determines as at 416 if the ADS-B-N number matches the Master N number. If not, the number mismatch is set to “Yes” as at 418. Regardless, the system then proceeds to FIG. 15 and notated element “2”. As shown in FIG. 15, a determination is made at 420 as to whether the aircraft manufacturing code is valid. If so, the system Obtains the aircraft reference owner information as at 422. If not, the aircraft field values are set to “no data” as at 424. If the aircraft reference information is not valid as determined at 426, the aircraft field values are set to “no data” as at 424. If the aircraft reference information is valid as determined at 426, the system sets the aircraft field values as at 428. Both 424 and 428 proceed next to determine whether the engineering manufacturing code is valid as at 430. If not, the system sets the engine field values to no data as at 432 and proceeds to notated element “3” in FIG. 16. If so, the system obtains engine manufacturing data such as through a text file as at 434 and determines if such data is valid as at 436. If not, the system sets the engine field values to no data as at 432 and proceeds to notated element “3” in FIG. 16. If so, the system sets the engine field values as at 438 and proceeds to notated element “3” in FIG. 16.

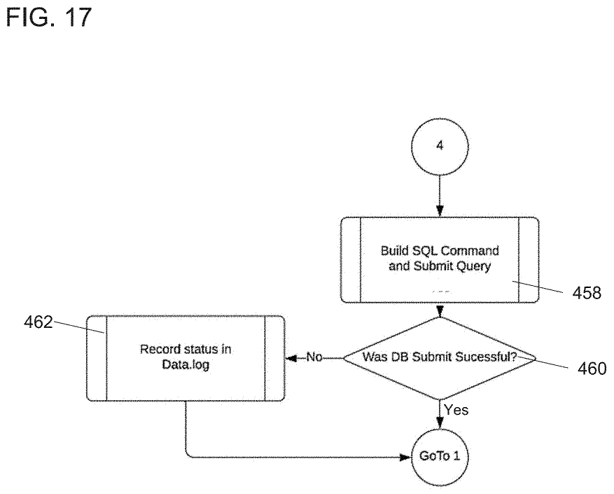

At notated element “3” in FIG. 16, the system looks up the state and county and sets the FAA field value as at 440. In various embodiments, the system then determines whether the registrant's region is European as at 442. If so, the system looks up the international country string and sets the FAA field value as at 444. If not, or after 444, all remaining FAA field values are formatted and set as at 446. Adaptive filters are then applied to the operation type as at 448 and it is determined if the event was rejected as at 450. If not, ADS-B date/time data is converted to DATETIME format as at 452 and a determination is made as to whether the date/time conversion was successful as at 454. If the event was rejected, or if the date/time conversion was not successful, the status is recorded as at 456 and the system returns to notated element “1” in FIG. 14. If the date/time conversion was successful, the system proceeds to notated element “4” in FIG. 17. As shown in FIG. 17, at 458, an SQL command can be built and a query submitted. If the database query was not successful as at 460, the status can be recorded in the log as at 462. If the database query was successful as at 460, the system can return to notated element “1” in FIG. 14.

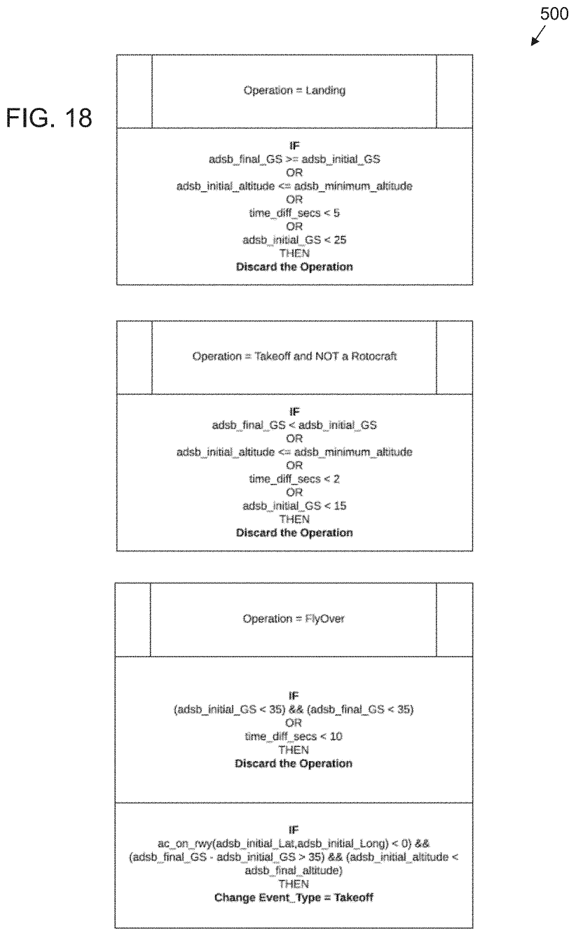

Operation filters are shown in diagram 500 of FIG. 18, including when the operation is a. landing, when the operation equals and the aircraft is not a rotocraft, and when the operation is a flyover. These filters reject ADS-B events that are caused by erroneous ADS-B messages which can be due to improper installation or user configuration.

In order to monitor the critical programs/processes that are running on the ADS-B Data Acquisition Unit (e.g., at the airport) and the Remote “Event processing and Database Server”, embodiments of the present disclosure include programming that constantly checks that all the critical processes are running on both systems. In the event any one of the processes listed above is no longer running, the system sends a notification message immediately to appropriate personnel via a text message and/or email, for example. In addition, the program can restart the parent and child processes.

In various embodiments, the system of the present disclosure includes a low power radar simulator and a low power ADS-B transmitter. The radar simulator can produce a secondary surveillance radar (SSR) signal to cause vehicles in the vicinity and on the ground to reply with an ADS-B surveillance II) message containing the vehicle's transponder code. Ordinarily, a vehicle's ADS-B system only sends an ADS-B surveillance ID message when it is pinged or interrogated by a true SSR signal from an FAA SSR. radar system as the vehicle is operated in the transmission range, which is typically 3,000 feet above ground level of an operating FAA SSR, The radar simulator according to the present disclosure can be operated below this level and can in various embodiments trigger the the vehicle's ADS-B unit to send its transponder code while on the ground and before takeoff, or at least when it is close to the airport.

In various embodiments, the ADS-B transmitter can be employed to send a standard ADS-B message for end-to-end test messaging of a complete system according to the present disclosure in real time. During late night and/or early morning, there are very few vehicles/aircraft in many locations. Where there are no vehicles sending ADS-B messages, embodiments of the present disclosure have no vehicle detections and no way to distinguish if there are truly no vehicles sending ADS-B messages or that there may potentially be a failure in the antenna, cabling or other aspects of the present disclosure such that it appears the system and/or device is “running” but no aircraft are being detected. By providing an ADS-B message transmitter with the ability to send a test message out, this test message would be received and processed to provide full end-to-end validation that all components of the system are in place and operating appropriately.

In various embodiments, the present disclosure further provides an autonomous data processing platform or system operable by host 20. This system can be embodied as a cloud-based computing platform (e.g., host 20) that receives data from the IOT sensor platform 12 for storage, analyzes, cleans and processes the IOT sensor data, fuses the IOT sensor data with external data sources and forwards the data to external systems via a network. The system can support processing of data to report on aircraft time in service (subject to their taking off and landing at an airport with an installed monitoring system), and can further support data visualization, reporting and the transmission of data to external visualization and reporting systems via a network. The system can fuse data received from sensors with data from the FAA, airports and other stakeholders to support analysis and reporting on parameters that include make/model of aircraft, aircraft gross weight, aircraft number of seats, local vs transient operations, aircraft registration information and VFR vs IFR aircraft (the use of Air Traffic Control services), for example. Optionally, the present system can generate and transmit alerts and notifications based on configurable event parameters such as aircraft identification, aircraft owner, aircraft location and/or time, for example.

Programming associated with the IOT subsystem 12, such as within the ADS-B processor 32 in FIG. 4 can operate several tasks/responsibilities, including but not limited to:

a. Configuring the SDRs (frequency, gain, socket (IP and Port), A/C transponder data, airport reference point, radio reception range in nm).

b. Starting decoding programs.

c. Receiving the ADS-B message (e.g., SBS formatted) data from the decoding programs, parsing the data into individual variables, validating the data using regular expressions, and discarding bad data.

d. Determining if the vehicle is entering a geofence volume, leaving the geofence, within the airport runway geometry, airborne or on the ground, if this vehicle is currently being tracked, updating the vehicle and/or aircraft state array, adding a new vehicle of interest, determining if an event has occurred, processing the event, removing “stale” vehicles from the vehicle state array, and acquiring the airport barometric pressure via the FAA/NWS Aviation Digital Data Service every time a vehicle is being tracked and updated at least once per hour.

e. Launching a software program that sends the “operation event” to the remote server 20 for further processing and finally storage in database 22.

Further to the above, the aircraft or vehicle “state” array is a data structure that stores multiple ADS-B vehicle values. An exemplary state array may consist of a structure with the values as listed below. In various embodiments, each vehicle being tracked is allocated one state array structure. The identifying (index) is the vehicle's six-character (Hexadecimal) ICAO ID Code.

struct ac_state_array
int sa_initial_MSG_number;
int sa_current_MSG_number;
char sa_ICAO_ID[7];
char sa_N_Number[9];
char sa_Message_Date[11];
char sa_initial_Message_Time[13];
char sa_current_Message_Time[13],
int sa_initial_Altitude;
int sa_current_Altitude;
int sa_minimum_Altitude;
int sa_maximum_Altitude;
int sa_initial_GroundSpeed,
int sa_current_Groundspeed;
int sa_initial_Track;
int sa_current_Track;
float sa_initial_Latitiude;
float sa_initial_Longitude;
float sa_current_Latitude;
float sa_current_Longitude;
int sa_initial_OG_Flag;
int sa_current_OG_Flag;
int sa_Emitter_Category;
int sa_Type_Code
int sa_Completed_Flag;
double sa_initial_Distance_from_ap;
double sa_current_Distance_from_ap;
double sa_minimum_Distance_from_ap; int sa_previous_op;
int sa_Index;
int sa_VerticalRate;
int sa_ModeASquawkCode;
int sa_SquawkChangeFlag;
int sa_SquawkEmergencyFlag;
int sa_SPIFlag;
int sa_maximum_GS;
char wheels_up_time[13];
char duration_airborne[13];
char duration_onground[13];
char enter_geofence_t[MAX_GFS][1 .. 100]
char leave_geofence_t{MAX_GFS][1..100]
int transmission_format;
char wheels_down_time[13];
float Airport_Pressure_Altitude;
char AP_Wx_Category;
int wind_speed
int wind_direction
int operation_confidence_level
float RSSI
float Last_Known_Latitude
float Last_Known_Longitude
int Last_Known_Ground_Speed
int Last_Known_Track
int Last_Known_Altitude
float enter_GeoFence_Latitude[1..100]
float enter_GeoFence_Longitude[1..100]
int enter_GeoFence_Altitude[1..100]
int enter_GeoFence_Ground_Speed[1..00]
int enter_GeoFence_Track[1..100]
int enter_GeoFence_Vertical_Rate[1..100]
int enter_GeoFence_Squawk_Code[1..100]
char enter_GeoFence_Callsign[1..100][8]
float exit_GeoFence_Latitude[1..100]
float exit_GeoFence_Longitude[1..100]
int exit_GeoFence_Altitude[1..100]
int exit_GeoFence_Ground_Speed[1..00]
int exit_GeoFence_Track[1..100]
int exit_GeoFence_Vertical_Rate[1..100]
int exit_GeoFence_Squawk_Code[1..100]
char exit_GeoFence_Callsign[1..100][8]
float elapsed_time_in_GeoFence[1..100] // 20 or more
simultaneous geofences.
int score

As an example, a single dimensional array with one hundred elements, with each element as an aircraft or vehicle state array, is declared initially. This means the system can track one hundred vehicles simultaneously, although higher numbers are readily accommodated.

In various embodiments, a role of the remote server 20 is to receive the event message from the detection unit 14 and execute the following tasks:

1. Store/Archive the event message on the cloud/remote server 20.

2. Parse validate the comma separated values into individual variables.

3. Determine the event (e.g., TA (take oft), LA (landing), TR (transiting aircraft), (touch and go), FO (flyover or missed approach), etc.).

4. Apply filtering algorithms and/or “control laws” to eliminate/discard false ADS-B events due to intermittent squat switches on retractable aircraft, incorrect altimeter aircraft settings, intermittent “on Ground” messages from an aircraft in the air, and other messages.

5. Determine the runway used.

6. Use the aircraft ICAO code to lookup FAA owner registration data, FAA aircraft reference data and lookup if the aircraft is based at the airport using a list of home-based aircraft provided by an airport database system.

7. Connect to the database 22 and insert the event into the database 22.

It will be appreciated that the database 22 can be accessible remotely from a dashboard server for visual presentation and custom reports can be produced, such as through analysis and visualization component 21. FAA registration data is public and available from an external source 24 such as the FAA registration website. For example, IAS data may consist of six individual fixed length text records files. These files are updated daily by the FAA and can be uploaded to the remote server 20 and database 22 via an automated script. All of the data that is successfully stored in the database 22 is accessible by the dashboard. A dashboard server (e.g., component 21) can query the database table and then populate the dashboard graphs and lists. Such processing can be performed in real-time or on a periodic basis, such as every few hours, for example.

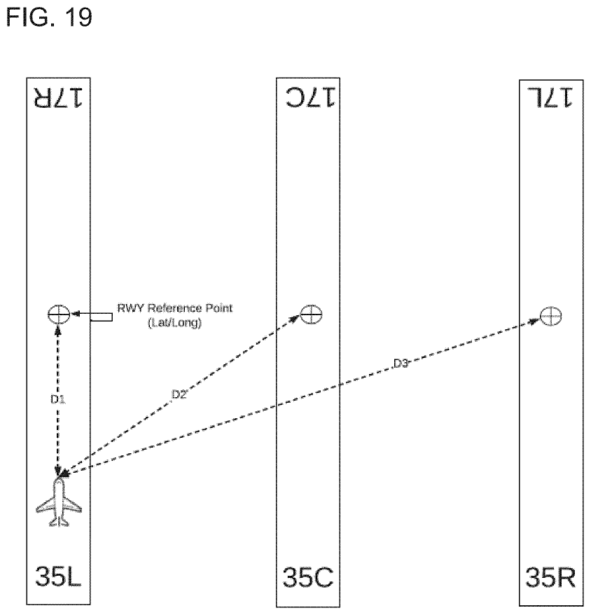

As illustrated in FIG. 19, in determining which one of multiple, parallel or crossing runways an operation occurred on, the system of the present disclosure can calculate the distance from the vehicle's takeoff or landing position to a reference point on the runway. Then given the latitude/longitude: of the vehicle and the latitude/longitude: of the reference point, the “shortest” distance from the vehicle to the reference point determines which runway the operation occurred on. In various other embodiments, the system can employ a “point inside a box” method when there are parallel or crossing runways, the lengths of the runways are not equal or their thresholds are not aligned. In such case, the vehicle's position (latitude/longitude) can be checked to see if it is within the runway boundary of a particular runway. In this manner, the system supports heliports, vertiports and improvised airfields.

In various embodiments, determinations of the distance between two points {Lat/long) can be determined in feet as ACOS(COS(RADIANS(90-Lat1))*COS(RADIANS(90-Lat2)) +SIN{RADIANS(90-Lat1))*SIN{RADIANS(90-Lat2))*COS{RADIANS(Long1-Long2)))*(3958.756)*(5280).

In various embodiments, the system can create multiple time-based geofences of various shapes at fixed and moving positions. In various embodiments, the space of the geofence can be any spherical or polygenic (e.g., square, triangle etc.) shape. It may be defined by a “base” altitude to a “ceiling” altitude, The geofence can be located at a fixed location or it can be “moving” with a vehicle such as an aircraft or drone, for example. A fixed (stationary) geofence may be used for airport operations counting, noise sensitive areas or any airspace that needs to be monitored for air traffic. A dynamic or moving geofence can be used to monitor any aircraft within a defined volume relative to a moving reference point (e.g., drone, aircraft). In various embodiments, notifications can be sent by the present system depending upon the obtained and processed information. For example, upon detecting an “event”, the presently described system can obtain vehicle and owner registration data and combine that with detected information in reporting a violation to another party such as an authority that may issue a notice or an associated fine or penalty. As a specific example, the system herein can determine, for example, that aircraft N123BC, a SR-20, is owned by Larry Loud and was inside the noise sensitive area defined as GeoFencel, at 01:15:55 on Nov. 16, 2020, alt=3500 ft above ground level, with latitude/longitude position and speed as detected. Such a notification may result in Larry Loud receiving a fine or other penalty as determined by the appropriate authority receiving the notification from the present system. The system can be configured to not generate a notification if the same event happened at, for example, 11:00 in the morning.

It will thus be appreciated that embodiments of the present disclosure provide, in part, a method, device and system for providing accurate and current surveillance of airport, aircraft and related vehicle operations. The method, device and system can leverage ADS-B data from aircraft and other vehicles for improved airport and aircraft operations and tracking, particularly at and near the ground. In various embodiments, the method, device and system can perform taxiway utilization analysis such as by monitoring vehicle movement, location and paths and determine which taxiways are being used by counting when a vehicle crosses into, traverses and exits a specific area of tarmac, taxiway, apron or any physical location on the airport property. The vehicle registration information along with the number of times the vehicle is occupying one of these areas or geofences can be detected and recorded.

Embodiments of the present disclosure can further use ATC voice transmissions/recordings from pilots and air traffic control to determine takeoff/landing/flyover counts, whereby the audio can be processed using speech to text conversion and wherein textual parsing is conducted to detect when an aircraft operation has occurred. Embodiments of the present disclosure can further provide an airport surface detection surveillance system that provides tracking and visibility of surface movement of aircraft and vehicles to help reduce critical Category A and B runway incursions. Embodiments of the present disclosure can further provide alerts and/or detected event notifications of potential runway incursions or conflicts by providing detailed coverage of movement on runways and taxiways. Various embodiments can also provide for vertical takeoff and landing (VTOL) and/or unmanned aerial system (UAS) counts, accounting for non-ADS-B protocol signal reception, for example. In some embodiments, weather conditions can be integrated with operations as described herein, and the present system can forecast counts based on past data and/or environmental conditions, for example. In still other embodiments, airport operations attributable to specific operators (e.g., FBOs, flight schools, clubs, individual operators) can be tracked, the impact of airport improvement initiatives on volume and nature of operations can be tracked and quantified, and “spot landing” analysis can be supported. Spot landing analysis can assess whether and where an aircraft actually touched down within a specific area, which can be employed in pilot training, safety and even games and contests. The presently disclosed system, method and device can further be employed for traffic pattern safety analysis to see, for example, how pilots are actually flying within stated traffic patterns and/or where additional training may be needed. Further embodiments can assist with fraud detection and remediation, such as when an operator employs a self-service fuel pump at an airport and may intentionally or accidentally forget to pay, for example.

Unless otherwise stated, devices, modules or components associated with the present disclosure that are in communication with each other do not need to be in continuous communication with each other. Further, devices, modules or components in communication with other de⁻vices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algotithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present disclosure include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random-access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present disclosure to a processor. For example, sequences of instruction can be delivered from RAM to a processor, carried over a wireless transmission medium, and/or formatted according to numerous formals, standards or protocols, such as Transmission Control Protocol/Internet Protocol (TCP/IP), Wi-Fi, Bluetooth, GSM, CDMA, satellite, EDGE and EVDO, for example. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present disclosure, as will be understood to one of ordinary skill in the art.

The present disclosure describes numerous embodiments of the present disclosure, and these embodiments are presented for illustrative purposes only. These embodiments are described in sufficient detail to enable those skilled in the art to practice the disclosure, and it will be appreciated that other embodiments may be employed and that structural, logical, software, electrical and other changes may be made without departing from the scope or spirit of the present disclosure. Accordingly, those skilled in the art will recognize that the present disclosure may be practiced with various modifications and alterations. Although particular features of the present disclosure can be described with reference to one or more particular embodiments or figures that form a part of the present disclosure, and in which are shown, by way of illustration, specific embodiments of the disclosure, it will be appreciated that such features are not limited to usage in the one or more particular embodiments or figures with reference to which they are described. The present disclosure is thus neither a literal description of all embodiments of the disclosure nor a listing of features of the disclosure that must be present in all embodiments.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein refers to various configurations of: (a) one or more remote servers, central controllers, or remote hosts; and/or (b) one or more IOT subsystem servers and/or (c) one or more personal computing devices, such as desktop computers, laptop computers, tablet computers or computing devices, personal digital assistants, mobile phones, and other mobile computing devices. A system as used herein may also refer to: (d) a single central server, central controller, or remote host; and/or (e) a plurality of central servers, central controllers, or remote hosts in combination with one another; and/or (f) a single IOT subsystem server; and/or (g) a plurality of IOT subsystem servers in combination with one another.

In certain embodiments in which the system includes a central server, central controller, IOT subsystem server or remote host, the central server, central controller, IOT subsystem server or remote host is any suitable computing device (such as a server) that includes at least one processor and at least one memory device or data storage device. The processor of the additional device, central server, central controller, IOT subsystem server or remote host is configured to transmit and receive data or signals representing events, messages, commands, or any other suitable information between the central server, central controller, IOT subsystem server or remote host and the additional device.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented as entirely hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Pert, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. in the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

1. A system for enhancing airport and aircraft operations, comprising:
an airport monitoring subsystem comprising a detection unit, where the detection unit comprises:
an ADS-B radio receiver connected to an antenna and operable to receive ADS-B transmissions from a vehicle;
a processor; and
a memory storing instructions which, when executed by the processor, cause the processor to:
define a geofence volume;
receive an ADS-B transmission from the ADS-B radio receiver when the vehicle is entering, within or leaving the defined geofence volume;
detect whether the vehicle is performing a pre-established aircraft operation; and
upon detecting that the vehicle is performing a pre-established aircraft operation, generate a detected event notification.

2. The system of claim 1, wherein the airport monitoring subsystem further comprises an airport DataComm unit, wherein the DataComm unit comprises a data modem/router connected to the detection unit and a network.

3. The system of claim 1, wherein the detection unit receives ADS-B transmissions from the vehicle while the vehicle is on the ground

4. The system of claim 1, wherein the detection unit records, from the received ADS-B transmission, one or more of the vehicle's position, altitude, groundspeed, track, transponder code, identification code, tail number and on ground status in detecting that the vehicle is performing a pre-established vehicle operation.

5. The system of claim 1, wherein the geofence volume comprises one of: an area around an airport, an area around an airport runway, a time period and a noise sensitive area.

6. The system of claim 1, wherein the geofence volume comprises a defined volume of airspace surrounding a UAV.

7. The system of claim 1, wherein the instructions further cause the processor to identify suspected mis-configured ADS-B installations in the vehicle.

8. The system of claim 1, wherein the instructions further cause the processor to determine if the vehicle is on a tracking list or to be placed on a tracking list.

9. The system of claim 1, further comprising a sensor comprising at least one of: a radar sensor, a LiDAR sensor, a forward looking infrared (FLIR) sensor and a wildlife sensor.

10. The system of claim 1, wherein the geofence volume is static.

11. The system of claim 1, wherein the geofence volume is dynamic.

12. The system of claim 1, wherein the notification comprises an ADS-B Out or other transmission to the vehicle.

13. A device, comprising:
a processor;
a memory device storing a plurality of instructions which, when executed by the processor, cause the processor to:
define a geofence volume;
receive an AI)S-B transmission from a vehicle;
determining, from the ADS-B transmission that the vehicle is entering, within or leaving the defined geofence volume;
detect whether the vehicle is performing a pre-established vehicle operation; and
upon detecting that the vehicle is performing a pre-established aircraft operation or penetrating the geofence volume, generate a detected event notification.

14. The device of claim 13, wherein the pre-established vehicle operation comprises a landing, a takeoff, a flyover, a transiting movement, an anticipated runway incursion, taxiing, a stable approach, a spot landing, a traffic pattern movement, a stop and go movement or a touch and go movement.

15. The device of claim 13, wherein the instructions further cause the processor to query an external data system based upon the received ADS-B transmission and build a merged data record, and where the notification comprises one of: a safety analysis for the vehicle, a noise violation, a weather report at the time of the detected operation, a landing fee assessment and a mis-configured ADS-B installation for the vehicle.

16. A method, comprising:
receive, via a radio receiver in communication with an antenna mounted at or near an airport, an ADS-B transmission from a vehicle;
determining, from the ADS-B transmission that the vehicle is performing a pre-established aircraft operation;
querying, by a host in communication with the detection unit, an external data system based upon the received ADS-B transmission to obtain identification information associated with the vehicle;
merging the identification information with the decoded message; and
generating a detected event notification.

17. The method of claim 16. further comprising receiving the ADS-B transmission from the vehicle while the vehicle is on the ground.

18. The method of claim 16, wherein the pre-established vehicle operation comprises a landing, a takeoff, a flyover, a transiting movement, an anticipated runway incursion, taxiing, a stable approath, a spot landing, a traffic pattern movement, a stop and go movement or a touch and go movement.

19. The method of claim 16, wherein the notification comprises one of: a safety analysis for the vehicle, a noise violation, a weather report at the time of the detected operation, a. landing fee assessment and a mis-configured ADS-B installation for the vehicle.

20. The method of claim 16, wherein the geofence volume comprises one of: an area around an airport, an area around an airport runway, a time period and a noise sensitive area.
